(19) United States
(12) Patent Application Publication
(10) Pub. No.: US 2008/0158705 A1
(43) Pub. Date: Jul. 3, 2008

(54) Write head tester

(76) Inventors: Xiaodong Che, Saratoga, CA (US); Wen-chien Hsiao, San Jose, CA (US); Yansheng Luo, Fremont, CA (US); Xiaoyu Sui, Fremont, CA (US)

Correspondence Address: HITACHI C/O WAGNER BLECHER LLP, 123 WESTRIDGE DRIVE, WATSONVILLE, CA, 95076, US

(21) Appl. No.: 11/648,368

(22) Filed: Dec. 28, 2006

(51) Int. Cl. G11B 27/36

(52) U.S. Cl. 360/31

(57) ABSTRACT

A write head tester is disclosed. The write head tester includes a rotatably coupled magnetic media having a stand-off thereover. In addition, a write head holder is fixedly coupled with the tester. The write head holder receives and electrically couples a removably coupleable write head such that the removably coupleable write head is capable of performing a write on the magnetic media. A read head is also fixedly coupled with the tester. The read head is utilized for performing a read on the magnetic media. Furthermore, an evaluator is provided for accessing a result of the read on the magnetic media and evaluating the removably coupleable write head based on the read.

### FIELD OF THE INVENTION

The present invention relates to hard drives and more particular to write head testing.

### BACKGROUND OF THE INVENTION

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model was established approximately 50 years ago and resembles a phonograph. That is, the hard drive model includes a storage disk or hard disk that spins at a standard rotational speed. An actuator arm or slider is utilized to reach out over the disk. The arm has a magnetic read/write transducer or head for reading/writing information to or from a location on the disk. The complete assembly, e.g., the arm and head, is called a head gimbal assembly (HGA).

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable hard drives such as those used in personal digital assistants (PDAs), MP3 players, and the like. For example, the original hard disk drive had a disk diameter of 24 inches. Modern hard disk drives are much smaller and include disk diameters of less than 2.5 inches (micro drives are significantly smaller than that). Advances in magnetic recording are also primary reasons for the reduction in size.

Moreover, because of the reduction in size and therefore a need to reduce manufacturing costs, present head manufacture is extremely cost sensitive. Moreover, the head manufacturing business success is based on a quality wafer, slider and HGA process control, monitoring and testing. The major performance challenge these days is writer related.

Presently, a dynamic electric tester (DET) is used to evaluate the write information. However, the DET testing is costly and also requires a complete HGA assembly when testing the write head. Thus, when a write head fails, the entire HGA assembly must be scrapped.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A write head tester is disclosed. The write head tester includes a rotatably coupled magnetic media having a stand-off thereover. In addition, a write head holder is fixedly coupled with the tester. The write head holder receives and electrically couples a removably coupleable write head such that the removably coupleable write head is capable of performing a write on the magnetic media. A read head is also fixedly coupled with the tester. The read head is utilized for performing a read on the magnetic media. Furthermore, an evaluator is provided for accessing a result of the read on the magnetic media and evaluating the removably coupleable write head based on the read.

### BRIEF DESCRIPTION OF THE DRAWINGS

The above and other objects and advantages of the present invention will be more readily appreciated from the following detailed description when read in conjunction with the accompanying drawings, wherein:

FIG. 1 is a plan view of a hard disk drive (HDD) with cover and top magnet removed in accordance with one embodiment of the present invention.

FIG. 2 is a block diagram of an exemplary write head tester in accordance with embodiments of the present invention.

FIG. 3 is a block diagram of a top view of an exemplary write head in accordance with embodiments of the present invention.

FIG. 4 is a block diagram of an exemplary bar of write heads in accordance with embodiments of the present invention.

FIG. 5 is a flowchart of an exemplary method for testing a write head in accordance with embodiments of the present invention.

### DETAILED DESCRIPTION

Reference will now be made in detail to embodiments of the present technology, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

### Overview

The present technology is utilized to test a write head before it is assembled in a HGA. Moreover, in one embodiment, the testing of the write head is performed while the head is still in the wafer bar. That is, before the wafer bar is cut into a plurality of slider heads. In so doing, each write head at each section of the wafer bar can be tested in an automated, assembly line fashion.

In one embodiment, in order to adjust for the write stand-off required by the write head, that is the stand-off normally provided by the HGA, a stand-off layer may be provided above the magnetic media of the testing device. In general, the stand-off layer provides proper spacing of the write head.

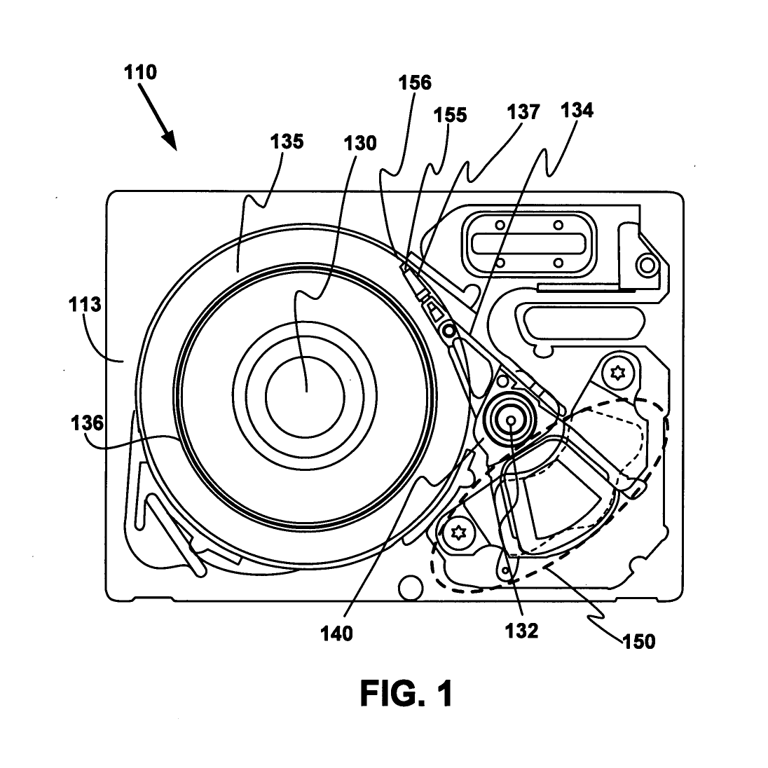

With reference now to FIG. 1, a plan view of a hard disk drive (HDD) with cover and top magnet removed is shown in accordance with one embodiment of the present invention. HDD 110 is provided herein to provide context for the following description of the write head tester and one embodiment of write heads tested thereon, that is, slider write heads.

FIG. 1 illustrates the relationship of components and sub-assemblies of HDD 110 and a representation of data tracks 136 recorded on the disk surfaces 135 (one shown). The cover is removed and not shown so that the inside of HDD 110 is visible. The components are assembled into base casting 113, which provides attachment and registration points for components and sub-assemblies.

A plurality of suspension assemblies 137 (one shown) are attached to the actuator arms 134 (one shown) in the form of a comb. A plurality of transducer heads or sliders 155 (one shown) are attached respectively to the suspension assemblies 137. Sliders 155 are located proximate to the disk surfaces 135 for reading and writing data with magnetic read and write heads 156 (one shown). The rotary voice coil motor 150 rotates actuator arms 134 about the actuator shaft 132 in order to move the suspension assemblies 150 to the desired radial position on disks 112. The actuator shaft 132, hub 140, actuator arms 134, and voice coil motor 150 may be referred to collectively as a rotary actuator assembly.

Data is recorded onto disk surfaces 135 in a pattern of concentric rings known as data tracks 136. Disk surface 135 is spun at high speed by means of a motor-hub assembly 130. Data tracks 136 are recorded onto spinning disk surfaces 135 by means of magnetic heads 156, which typically reside at the end of sliders 155. FIG. 1 being a plan view shows only one head, slider, and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

### Write Head Tester

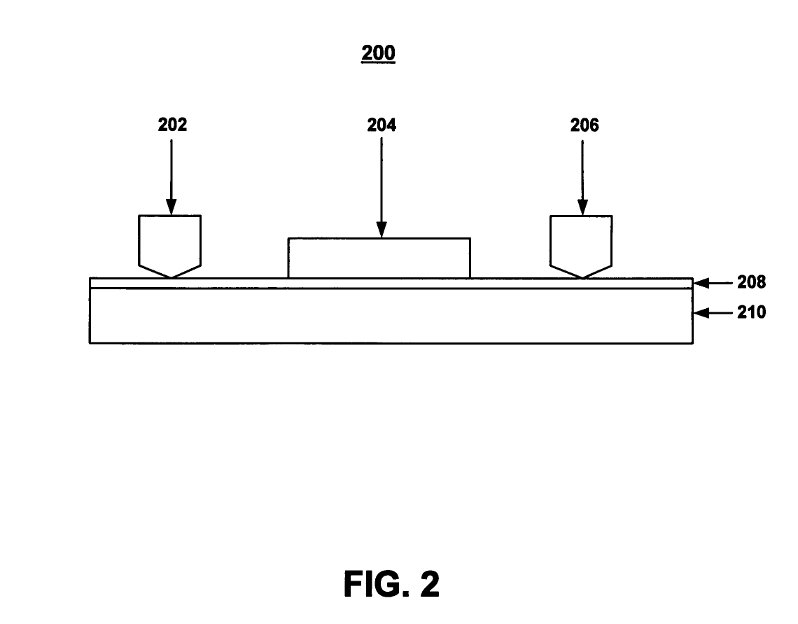

With reference now to FIG. 2, a block diagram of an exemplary write head tester 200 is shown in accordance with one embodiment of the present invention. In one embodiment, write head tester 200 includes a rotatably coupled magnetic media 210 having a stand-off layer 208 thereover, a read head 206, and a write head holder 204. In one embodiment, write head tester 200 also includes an optional write head 202. In general, magnetic media 210 has similar magnetic properties to HDD surface 135 of FIG. 1.

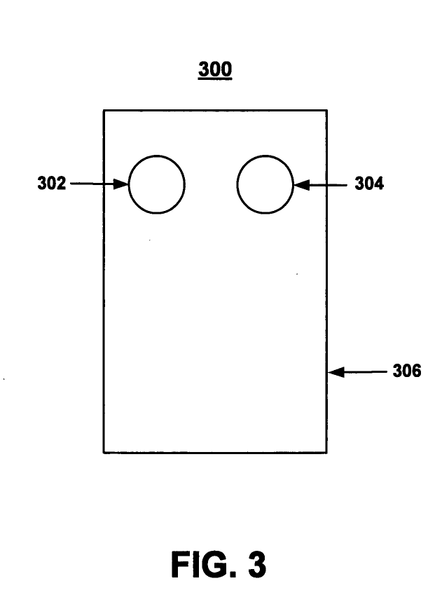

In one embodiment, optional write head 202, write head holder 204 and read head 206 are fixedly coupled with write head tester 200. That is, each is integral with the write head tester 200 and as such, the stand-off and calibrations for read head 206, write head holder 204, and optional write head 202 are constant. In general, stand-off layer 208 allows a write head (to be tested) that is electrically and removably coupled with write head holder 204 to also be automatically placed in an operational location with respect to magnetic media 210. That is, stand-off layer 208 provides a pre-defined distance between the write head to be tested and magnetic media 210. In so doing, the removably coupleable write head (e.g., 302 of slider assembly 300 of FIG. 3) can be positioned at a correct stand-off without requiring the write head (e.g., ) to be assembled in an HGA. Furthermore, stand-off layer 208 allows testing of contact or non contact recording write heads 302.

In one embodiment optional write head 202 may be used to precondition the magnetic media 210. For example, the preconditioning may include writing blank sectors or writing a pattern. That is, in one embodiment, prior to testing the removably coupleable write head, magnetic media 210 will be preconditioned (e.g., erased) to provide a clean write surface for the test. However, in another embodiment, there may not be an optional write head 202 and the preconditioning may be performed by other methods, such as, for example with a magnet.

Referring now to FIG. 3, a block diagram of an exemplary slider assembly 300 is shown in accordance with one embodiment of the present invention. Slider assembly 300 includes a write head 302 and read head 304 which are coupled to slider body 306. In one embodiment, slider assembly 300 may also include a plurality of contacts to provide electrical connectivity between the write head 302 and write head holder 204 of FIG. 2.

In one embodiment, the write head holder 204 includes a current driver which provides positive and negative current at a given rate. Besides varying current, the write head tester 200 may also test the performance of write head 302 of slider assembly 300 at varying temperatures. Further, the current driver can be coupled to the same pads on slider assembly 300 that are used for coupling to the HGA. In another embodiment, the current driver could be coupled to special pads made specifically for production testing on the slider assembly 300.

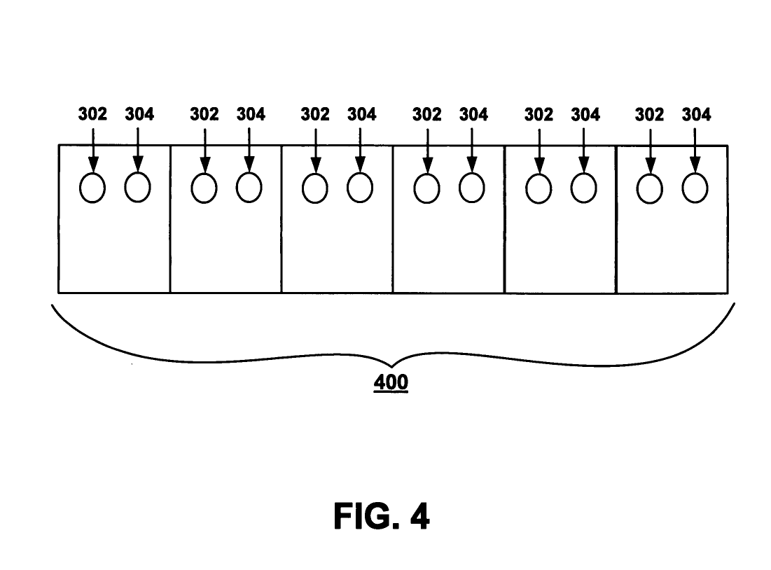

With reference now to FIG. 4, a block diagram of an exemplary bar 400 of a plurality of slider assemblies 300 is shown. As shown in FIG. 3, in one embodiment, each of the slider assemblies 300 includes as slider body 306, write head 302 and read head 304. For example, slider assemblies 300 will be formed at the wafer level and then the rows of the wafer will be separated into a plurality of bars 400. In another embodiment, there may be an electrical channel such that each write head 302 for an entire bar of slider assemblies 300 can be tested concurrently. In yet another embodiment, each write head 302 on the bar 400 of slider assemblies 300 could be automatically moved into testing position such that each of write head 302 could be tested sequentially. In one embodiment, bar 400s may be received directly from a machine which cut the bar 400s.

### Operation

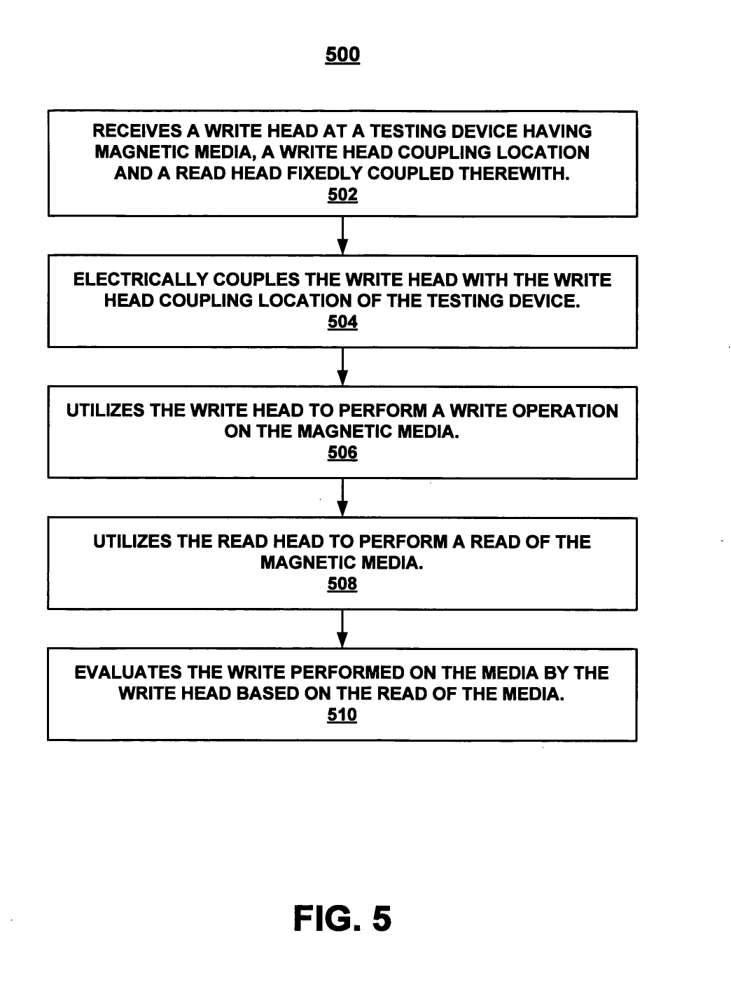

With reference now to FIG. 5 and to FIG. 2, an exemplary flowchart 500 of a method for testing write performance of a write head 302 prior to the write head 302 being coupled with a HGA is shown in accordance with one embodiment of the present invention. In general, the pre-coupling testing of write head 302 utilizing write head tester 200 has several advantages. One advantage is the facilitating of the rejection of a slider assembly 300 prior to incurring the cost and time of coupling the w slider assembly 300 to a HGA. Thus, there is no waste of HGAs or other manufacturing components as a result of a write head 302 rejection. Moreover, utilizing write head tester 200 also facilitates feedback to the wafer and write head 302 manufacturers without the delay of shipping, HGA mounting and DET.

With reference now to step 502 of FIG. 5 and to FIGS. 2 and 3, one embodiment receives write head 302 at a testing device 200 having magnetic media 210, a write head coupling location (e.g., write head holder 204) and read head 206 fixedly coupled therewith. In one embodiment, write head 302 is a portion of a slider assembly 300. However, in another embodiment, write head 302 is not a portion of a slider assembly. Thus, for purposes of brevity and clarity, the portion being received at write head holder 204 is referred to herein as write head 302 even though there may be wafer and other components associated therewith.

In one embodiment, write head 302 may be received from a machine operator or automatically. In another embodiment, a bar 400 of write heads 302 is received for testing. This receiving of write head 302 occurs prior to coupling to an HGA and any DET testing.

With reference now to step 504 of FIG. 5 and to FIG. 2, one embodiment electrically couples write head 302 with write head holder 204 of write head tester 200. That is, in one embodiment, write head 302 will be coupled to a current driver of write head holder 204 which can generate positive and negative current at a given rate which facilitates write head 302 performing write operations on magnetic media 210. In addition, the write head tester 200 may also vary the temperature as the operations are performed on magnetic media 210.

In one embodiment, the current driver is coupled to write head 302 using the same pads normally used when slider assembly 300 is coupled to a HGA. In another embodiment, the current driver is coupled to special production testing pads specifically provided on a portion of slider assembly 300. For example, the current driver could be coupled to pads specially made for early production testing. This pre-coupling testing of write head 302 has the advantage of allowing the rejection of slider assembly 300 prior to incurring the cost and time of coupling slider assembly 300 to a HGA. Thus, there is no waste of HGAs as a result of being attached to slider assembly 300 having a rejected write head 302 thereon.

With reference now to Step 506 of FIG. 5 and to FIG. 2, one embodiment utilizing write head 302 to perform a write operation on magnetic media 210. In one embodiment, prior to any activity on magnetic media 210 by write head 302, optional write head 202 may be used to precondition the magnetic media 210. For example, the preconditioning may include writing blank sectors or writing a pattern. This preconditioning could also be done by another means such as a magnet.

Furthermore, during the performance of the write, the saturation nature or range where a portion of magnetic media 210 has been fully magnetized and corresponds to the highest signal amplitude can be useful in evaluating write head holder 204 performance. For this reason, during the testing, one embodiment applies different write currents to write head 302 during the testing process to establish the saturation nature of write head 302. That is, the saturation nature of write head 302 can be determined based on which read yields the highest signal amplitude when the different writes to magnetic media 210 are read by read head 206.

Moreover, in one embodiment, write head 302 rests directly on stand-off layer 208 of magnetic media 210 when it is coupled with write head holder 204. That is, stand off layer 208 provides a stand-off write distance for write head 302 such that write head 302 is in direct contact with stand-off layer 208 above magnetic media 210 when in write orientation.

In general, stand-off layer 208 is between write head holder 204 and magnetic media 210 but allows write head holder 204 to write to magnetic media 210. Moreover, stand-off layer 208 provides the proper stand-off distance for write head 302 such that no further measurements or calibrations are necessary. In addition, stand-off layer 208 is interoperable with both contact and non-contact recording write heads 302.

With reference now to Step 508 of FIG. 5 and to FIGS. 2 and 3, one embodiment utilizes read head 206 to perform a read of magnetic media 210. For example, after a portion of magnetic media 210 passes under optional write head 202, it then passes under write head holder 204 where write head 302 performs a write. Then, the portion of magnetic media 210 passes under read head 206 and read head 206 reads the data written to magnetic media 210 by write head 302. In another embodiment, if the testing of a bar 400 of write heads 302 is being performed simultaneously, a plurality of portions of magnetic media 210 may be passed under the bar 400 of write heads 302 and then read by one or a plurality of read heads 206 thereby increasing the through rate of the testing process.

In one embodiment, the track width of optional write head 202 and the track width of read head 206 are both wider than the track width of write head 302. This ensures that the same track that read head 206 reads is the only track written by write head 302 being tested. For example, the signal written by write head 302 is directly proportional to the track width. In other words, a narrow band measurement can be used to increase sensitivity of the signal measurement for further evaluation of the write performed by write head 302.

In other words, since the read width of read head 206 is wider than the write width of write head 302, it is assured that the read head 202 will not read the track edge or outside the track written by write head 302. The result of read head 206 being wider than the write width of write head 302 means the read head 206 will be able to accurately measure the track width written by write head 302. Moreover, the signal amplitude written by write head 302 in write head holder 204 to magnetic media 210 is directly proportional to the track width. For example, when the track width is doubled then the signal or amplitude will be twice as strong. Thus, by calibrating the read signal from read head 206 with the known write head 302 width, the width of the signal written by write head 302 can be determined based on the amplitude read by read head 206. Furthermore, the sensitivity of the signal can be increased by use of a narrow band pass filter.

With reference now to Step 510 of FIG. 5 and to FIG. 2, one embodiment evaluates the write performed on magnetic media 210 by write head 302 based on the read of magnetic media 210. In one embodiment, the evaluation is based on the results of read head 206 reading of data on magnetic media 210. In so doing, the operational characteristics of write head 302 can be determined.

In another embodiment, the performance of write head 302 is based on various skews or bevel angles. For example, by applying differing bevel angles to write head 302 relative to the rotational direction of magnetic media 210, the magnetic write width of write head 302 can be measured as a function of the bevel angle. Based on this measurement, a prediction of the high skew performance conditions of write head 302, based on bevel angle, can be determined.

For example, the bevel angle may be varied in perpendicular writing situations to determine if bevel angle control is sufficient to obtain the write widths required by the inner diameter (ID) and outer diameter (OD) based on hard drive specifications. For example, the bevel angle might be varied from 90±10 degrees between ID and OD.

Furthermore, the saturation nature or range where a portion of magnetic media 210 has been fully magnetized and corresponds to the highest signal amplitude is also useful in evaluating write head 302 performance. For example, the saturation nature of write head 302 can be determined by applying different write currents via write head holder 204 to write head 302 to determine which current yields the highest signal amplitude.

After the evaluation is performed, each write head 302 (and in one embodiment, slider assembly 300) is either selected or discarded based on the results of the evaluation. That is, if it is determined that write head 302 can not write accurately, within the required skew range or the required saturation level, then write head 302 will be rejected and likely scrapped.

In so doing, the early decision of whether to use write head 302 in further production allows the rejections of slider assemblies 300 much earlier in the manufacturing process. Moreover, the feedback time to the wafer and head production facilities is also greatly reduced. For example, a write head testing process that took several days including shipping and HGA coupling, no longer requires these steps for rejecting a bad write head, thus, saving both time and money.

Thus, in one embodiment, write head 302 will be tested prior to coupling to an HGA and the solder bonding of the solder pads of the head to the suspension. Further, the head will be tested prior to Dynamic Electric Testing (DET) which is normally done after coupling to the HGA. This allows the quality and therefore the usability of a write head holder 204 to be determined before the cost of mounting and the time associated with DET is incurred.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A write head tester comprising:
a rotatably coupled magnetic media having a stand-off thereover;
a write head holder fixedly coupled with said tester, said write head holder for receiving and electrically coupling a removably coupleable write head such that said removably coupleable write head is capable of performing a write on said magnetic media;
a read head fixedly coupled with said tester, said read head for performing a read on said magnetic media; and
an evaluator for accessing a result of said read on said magnetic media and evaluating said removably coupleable write head based on said read.

2. The write head tester of claim 1 wherein said removably coupleable write head is a portion of a slider assembly not coupled with a head gimbal assembly.

3. The write head tester of claim 1 wherein said removably coupleable write head is a portion of a bar of slider assemblies, wherein each portion of said bar of slider assemblies having a write head thereon may be tested by said write head tester prior to cutting said bar into single slider assemblies.

4. The write head tester of claim 1 further comprising:
a second write head fixedly coupled with a second portion of said tester.

5. The write head tester of claim 4 wherein said second write head preconditions said rotatably coupled magnetic media.

6. The write head tester of claim 1 further comprising:
an electronics module coupled with said tester, said electronics module utilizing a narrow band pass filter to determine the signal strength of said write performed by said removably coupleable write head.

7. The write head tester of claim 1 wherein said removably coupleable write head contacts said stand-off when performing a write on said magnetic media.

8. The write head tester of claim 1 wherein said write is performed by said removably coupleable write head under various bevel angles.

9. A method for testing write performance of a write head prior to said write head being coupled with a head gimbal assembly, said method comprising:
receiving a write head at a testing device having magnetic media, a write head coupling location and a read head fixedly coupled therewith;
electrically coupling said write head with said write head coupling location of said testing device;
utilizing said write head to perform a write operation on said magnetic media;
utilizing said read head to perform a read of said magnetic media; and
evaluating said write performed on said media by said write head based on said read of said media.

10. The method of claim 9 further comprising:
receiving said write head coupled with a slider prior to attachment of said slider with a head gimbal assembly.

11. The method of claim 9 further comprising:
receiving a plurality of write heads coupled with a bar of sliders.

12. The method of claim 11 further comprising:
automatically testing each of said write heads on said bar of sliders.

13. The method of claim 9 further comprising:
evaluating said media with a narrow band pass filter.

14. The method of claim 9 further comprising:
utilizing a write head stand-off over said magnetic media, said write head stand-off providing a stand-off write distance for said write head such that said write head is in direct contact with said write head stand-off above said magnetic media when in write orientation.

15. The method of claim 9 further comprising:
testing the write head at various bevel angles.

16. The method of claim 9 further comprising:
evaluating the width of a write signal written to said media.

17. A method for testing write performance of a write head prior to said write head being coupled with a head gimbal assembly, said method comprising:
receiving a write head at a testing device having magnetic media, a write head coupling location and a read head fixedly coupled therewith;
electrically coupling said write head with said write head coupling location of said testing device;
utilizing a write head stand-off over said magnetic media, said write head stand-off providing a stand-off write distance for said write head such that said write head is in direct contact with said write head stand-off above said magnetic media when in write orientation;
utilizing said write head to perform a write operation on said magnetic media;
utilizing said read head to perform a read of said magnetic media; and
evaluating said write performed on said media by said write head based on said read of said media.

18. The method of claim 17 further comprising:
receiving said write head coupled with a slider prior to attachment of said slider with a head gimbal assembly.

19. The method of claim 17 further comprising:
receiving a plurality of write heads coupled with a bar of sliders; and
automatically testing each of said write heads on said bar of sliders.

20. The method of claim 17 further comprising:
evaluating said media with a narrow band pass filter.
